(19) United States
(12) Patent Application Publication
(10) Pub. No.: US 2026/0022678 A1
(43) Pub. Date: Jan. 22, 2026

(54) COATING SYSTEM

(71) Applicant: Volvo Truck Corporation, Göteborg (SE)

(72) Inventors: Patrick M. Holmes, Frederick, MD (US); Jian Li, Hagerstown, MD (US); Maxwell Taylor, Frederick, MD (US)

(21) Appl. No.: 19/266,840

(22) Filed: Jul. 11, 2025

(30) Foreign Application Priority Data
Jul. 17, 2024 (EP) 24189290.0

(51) Int. Cl. F02F 3/14

(52) U.S. Cl. CPC F02F 3/14; F02F 2200/00

(57) ABSTRACT

A coating system including a coating configured to be applied to a combustion surface of a piston and to initiate combustion of a gaseous fuel-air mixture; a first coating zone including the coating, the first coating zone being configured to correspond to a first combustion position on the combustion surface of the piston; and a second coating zone including the coating, the second coating zone being configured to correspond to a second combustion position on the combustion surface of the piston.

### PRIORITY APPLICATIONS

The present application claims priority to European Patent Application No. 24189290.0, filed on Jul. 17, 2024, and entitled “COATING SYSTEM,” which is incorporated herein by reference in its entirety.

### TECHNICAL FIELD

The disclosure relates generally to a piston included in an engine block of a vehicle. In particular aspects, the disclosure relates to a coating system configured for use on a combustion surface of a piston included in an engine block of a vehicle. The disclosure may relate to heavy-duty vehicles, such as trucks, buses, and/or construction equipment, among other vehicle types. However, although the disclosure may be described with respect to a particular vehicle, the disclosure is not restricted to any particular vehicle.

### BACKGROUND

An internal combustion engine and/or hybrid internal combustion engine of a vehicle typically includes an engine block defining one or more cylinder configured for reciprocation of a piston, which forms a combustion chamber. A gaseous fuel, such as a hydrogen-based fuel and/or a hydrocarbon-based fuel, is mixed with air and ignited in the combustion chamber. Pressure produced from combustion of the gaseous fuel mixed with air applies force on the piston, thereby converting chemical energy to mechanical energy.

Due to fuel injection and air intake dynamics, combustion chamber geometries, and/or the like, an imbalance in a ratio between gaseous fuel and air may be produced within the combustion chamber during combustion, creating regions of fuel-rich and fuel-lean concentrations. Fuel-lean regions of the combustion chamber cause sub-optimal combustion velocity, combustion rate, combustion spread, combustion duration, and/or combustion timing, which result in a decreased overall fuel combustion and consumption efficiency.

Additionally, in a hydrogen-based internal combustion engine and/or a hybrid hydrogen-based internal combustion engine, fuel-lean regions of the combustion chamber are exposed to excess water produced by combustion in fuel-rich regions of the combustion chamber, leading to thermal dilution and, thus, reduced ignition in fuel-lean regions before hydrogen present in the fuel-lean regions is burned. Incomplete combustion allows unburned hydrogen remaining in the combustion chamber to be absorbed into metal material used to construct components of the combustion chamber, which reduces ductility of the metal material and results in embrittlement and/or mechanical failure of the metal material and, thus, the combustion chamber.

It is desirable to provide a coating system configured for use on a combustion surface of a piston included in an engine block of a vehicle that is capable of directing combustion of a gaseous fuel-air mixture within the combustion chamber to reduce thermal dilution and incomplete combustion of the gaseous fuel-air mixture and, thus, improve fuel combustion and/or consumption efficiency, while also protecting one or more material used to construct components of the combustion chamber from embrittlement.

### SUMMARY

According to aspects of the disclosure, a coating system configured for use on a combustion surface of a piston is provided. The coating system includes a coating configured to be applied to a combustion surface of a piston and to initiate combustion of a gaseous fuel-air mixture. The coating system includes a first coating zone including the coating, the first coating zone being configured to correspond to a first combustion position on the combustion surface of the piston. The coating system includes a second coating zone including the coating, the second coating zone being configured to correspond to a second combustion position on the combustion surface of the piston.

According to aspects of the disclosure, the coating may include a first layer configured to decrease one or more of a thermal capacity and thermal conductivity of the coating.

According to aspects of the disclosure, the first layer may be configured to maintain a temperature of the coating within a range of 100° C. and 2,500° C.

According to aspects of the disclosure, the coating may include a second layer configured to decrease permeability of the coating.

According to aspects of the disclosure, the second layer may be configured to decrease permeation of hydrogen.

According to aspects of the disclosure, the coating may include a third layer including a catalyst configured to initiate combustion of the gaseous fuel-air mixture.

According to aspects of the disclosure, the catalyst may be configured to initiate combustion of hydrogen.

According to aspects of the disclosure, the first coating zone may be spaced-apart from the second coating zone.

According to aspects of the disclosure, the first combustion position may correspond to a first channel defined between a pair of radially-extending protrusions provided on the piston.

According to aspects of the disclosure, the second combustion position may correspond to a second channel defined between a pair of radially-extending protrusions provided on the piston.

According to aspects of the disclosure, the first combustion position and the second combustion position may correspond to regions of the combustion surface of the piston having a gaseous fuel-air ratio less than 0.029.

According to aspects of the disclosure, a piston configured for use in an engine block of a vehicle is provided. The piston includes a body extending between a first end and a second end about a longitudinal axis. The piston includes a crown at the first end of the body. The crown is configured for combustion of a gaseous fuel-air mixture. The crown includes a plurality of radially-extending protrusions. The piston includes the coating system according to any aspect of the disclosure presented herein.

According to aspects of the disclosure, each radially-extending protrusion of the plurality of radially-extending protrusions may be spaced-apart from an adjacent radially-extending protrusion of the plurality of radially-extending protrusions.

According to aspects of the disclosure, the piston according to any aspect presented herein may include a first channel defined between a first pair of radially-extending protrusions of the plurality of radially-extending protrusions and a second channel defined between a second pair of radially extending protrusions of the plurality of radially extending protrusions.

According to aspects of the disclosure, the first coating zone of the coating may be arranged within the first channel of the piston.

According to aspects of the disclosure, the first coating zone of the coating may be arranged on one or more radially-extending protrusion of the plurality of protrusions.

According to aspects of the disclosure, the second coating zone of the coating may be arranged within the second channel of the piston.

According to aspects of the disclosure, the second coating zone of the coating may be arranged on one or more radially-extending protrusion of the plurality of radially-extending protrusions.

According to aspects of the disclosure, a method of directing combustion of a gaseous fuel-air mixture along a combustion surface of a piston is provided. The method includes providing the coating system according to any aspect of the disclosure presented herein. The method includes applying the first coating zone of the coating to a first combustion position of a combustion surface of a piston. The method includes applying the second coating zone of the coating to a second combustion position of the combustion surface of the piston.

According to aspects of the disclosure, the method may include determining a region of the combustion surface of the piston having a gaseous fuel-air ratio less than 0.029.

According to aspects of the disclosure, the method may include applying the first coating zone spaced-apart from the second coating zone.

According to aspects of the disclosure, the method may include the first combustion position being included within a first channel defined between a first pair of radially-extending protrusions included by the piston and the second combustion position being included within a second channel defined between a second pair of radially-extending protrusions included by the piston.

In the manner described and according to aspects illustrated herein the coating system, the piston, and the method are capable of directing combustion of a gaseous fuel-air mixture within the combustion chamber to reduce thermal dilution and incomplete combustion of the gaseous fuel-air mixture and, thus, improve fuel combustion and/or consumption efficiency, while also protecting one or more material used to construct components of the combustion chamber from embrittlement.

The disclosed aspects, examples (including any preferred examples), and/or accompanying claims may be suitably combined with each other as would be apparent to a person having ordinary skill in the art. Additional features and advantages are disclosed in the following description, claims, and drawings, and in part will be readily apparent therefrom to persons skilled in the art and/or recognized by practicing the disclosure as described herein.

### BRIEF DESCRIPTION OF THE DRAWINGS

Aspects of the disclosure will be described with reference to the drawings, where like numerals reflect like elements:

FIG. 1 shows a perspective view of a vehicle according to aspects of the disclosure;

FIG. 2 shows a perspective view of an engine block of the vehicle of FIG. 1 according to aspects of the disclosure;

FIG. 3 shows a cross-sectional view of a cylinder, a piston, and a combustion chamber of the engine block of FIG. 2 according to aspects of the disclosure;

FIG. 4 shows a perspective view of a coating system configured for use on the piston of FIG. 3 according to aspects of the disclosure; and

FIG. 5 shows a front cross-sectional view of a coating of the coating system of FIG. 4 according to aspects of the disclosure.

### DETAILED DESCRIPTION

The detailed description set forth below provides information and examples with sufficient detail to enable those skilled in the art to practice the disclosure.

In the description, like numerals represent like parts. Although the technology disclosed herein is described with reference to specific examples, it should be understood that modifications and changes may be made to these examples without going beyond the general scope as defined by the claims. In particular, individual characteristics of the various examples shown and/or mentioned herein may be combined in additional examples. Consequently, the description and the drawings should be considered in a sense that is illustrative rather than restrictive. The Figures, which are not necessarily to scale, depict illustrative aspects and are not intended to limit the scope of the disclosure. The illustrative aspects depicted are intended only as exemplary.

The term “exemplary” is used in the sense of “example,” rather than “ideal.” While aspects of the disclosure are amenable to various modifications and alternative forms, specifics thereof have been shown by way of example in the drawings and will be described in detail. It should be understood, however, that the intention is not to limit aspects of the disclosure to a particular example described. On the contrary, the intention of this disclosure is to cover all modifications, equivalents, and alternatives falling within the scope of the disclosure.

Various materials, methods of construction, methods of fastening, and the like may be described in the context of disclosed examples. Those skilled in the art will recognize known substitutes for the materials, construction methods, fastening methods, and the like, all of which are contemplated as compatible with the disclosed example and are intended to be encompassed by the appended claims.

As used in this disclosure and the appended claims, the singular forms “a,” “an,” and “the” include plural referents, unless the content clearly dictates otherwise. As used in this disclosure and the appended claims, the term “or” is generally employed in a sense including “and/or,” unless the content clearly dictates otherwise.

Throughout the description, including the claims, the terms “comprising a,” “including a,” and “having a” should be understood as being synonymous with “comprising one or more,” “including one or more,” and “having one or more” unless otherwise stated. In addition, any range set forth in the description, including the claims, should be understood as including its end value(s), unless otherwise stated. Specific values for described elements should be understood to be within accepted manufacturing or industry tolerances known to one of skill in the art, and any use of the terms “substantially,” “approximately,” and “generally” should be understood to mean falling within such accepted tolerances.

When an element or feature is referred to herein as being “on,” “engaged to,” “connected to,” or “coupled to” another element or feature, it may be directly on, engaged, connected, or coupled to the other element or feature, or intervening elements or features may be present. In contrast, when an element or feature is referred to as being “directly on,” “directly engaged to,” “directly connected to,” or “directly coupled to” another element or feature, there may be no intervening elements or features present. Other words used to describe the relationship between elements or features should be interpreted in a like manner (e.g., “between” versus “directly between,” “adjacent” versus “directly adjacent,” etc.).

Spatially relative terms, such as “top,” “bottom,” “middle,” “inner,” “outer,” “beneath,” “below,” “lower,” “above,” “upper,” and the like may be used herein for case of description to describe one element or relationship of a feature to another element(s) or feature(s) as illustrated in the drawings. Spatially relative terms may be intended to encompass different orientations of a device in use or operation in addition to the orientation depicted in the drawings. For example, if the device in the drawings is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

Although the terms “first,” “second,” “third,” etc. may be used herein to describe various elements, components, regions, layers, sections, and/or parameters, these elements, components, regions, layers, sections, and/or parameters should not be limited by these terms. These terms are only used to distinguish one element, component, region, layer, section, or parameter from another element, component, region, layer, section, or parameter. Thus, a first clement, component, region, layer, section, or parameter discussed herein could be termed a second element, component, region, layer, section, or parameter without departing from the teachings of the present disclosure.

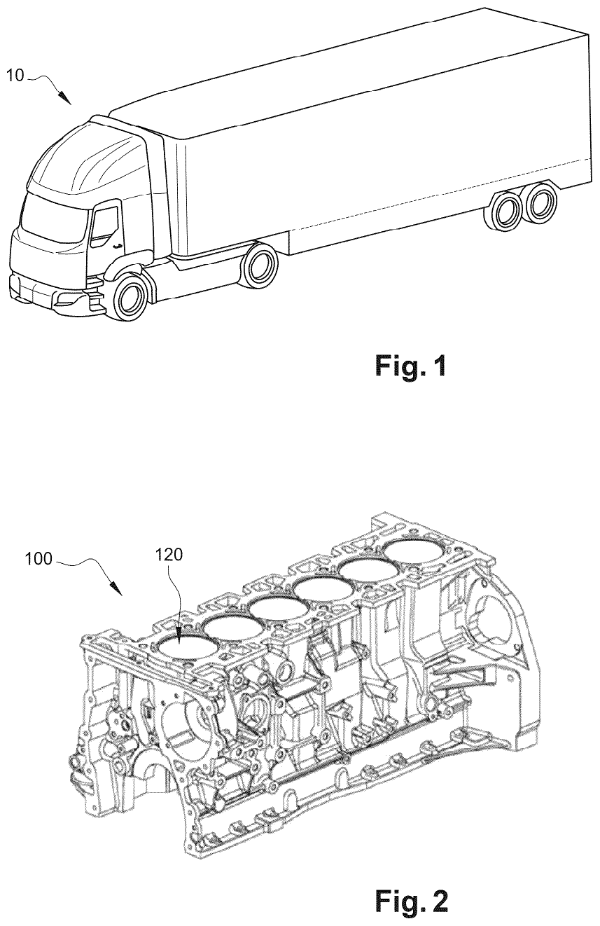

FIGS. 1 and 4-5 show a coating system 200 configured for use on a vehicle 10. Referring to FIG. 1, it is contemplated that the vehicle 10 may be a heavy-duty vehicle, such as a truck, bus, and/or construction equipment. However, it should be understood that the coating system 200 may be configured for use on other types of vehicles. It is contemplated that the coating system 200 may be configured for use on a hydrogen internal combustion engine vehicle, a hydrocarbon internal combustion engine vehicle, a battery electric vehicle, a fuel cell electric vehicle, and/or a hybrid thereof. However, reference to a hydrogen internal combustion engine vehicle will be used for purposes of the description, unless reference to a hydrocarbon internal combustion engine vehicle, a battery electric vehicle, a fuel cell electric vehicle, and/or a hybrid thereof is otherwise necessary.

Referring to FIGS. 1-3, the vehicle 10 to which the coating system 200 is configured for use on includes an engine (not shown). In examples, the engine may be a hydrogen internal combustion engine configured to utilize hydrogen as a primary source of gaseous fuel for combustion. In particular, hydrogen may be utilized as the primary source of gaseous fuel in combination with ambient air as a gaseous fuel-air mixture (not shown) for combustion.

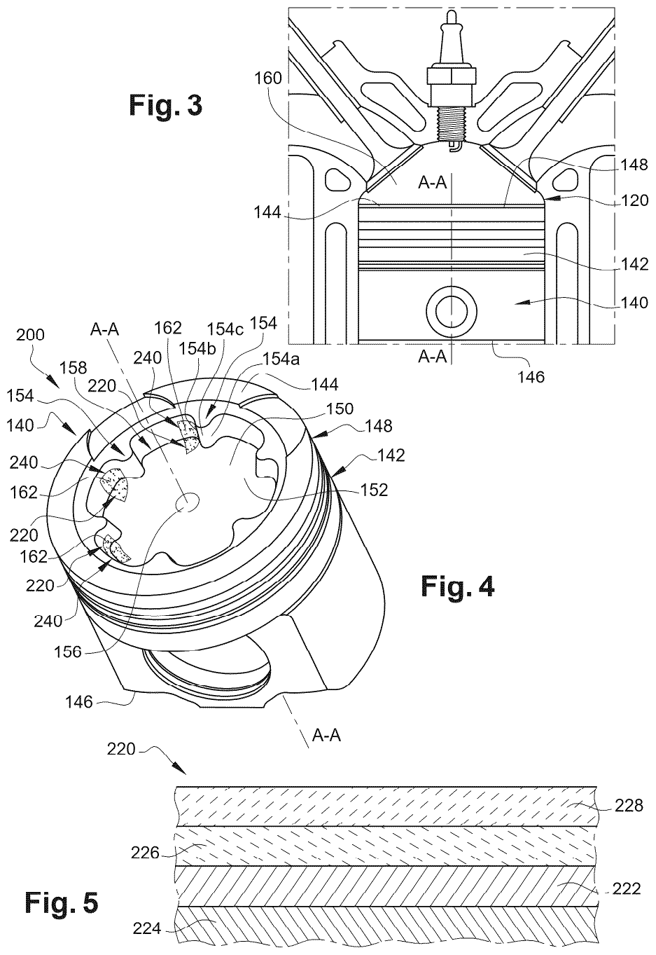

Referring to FIGS. 2-3, the engine includes an engine block 100 defining one or more cylinder 120 configured for reciprocation of a piston 140 (may also be referred to herein as a “wave piston 140”). It is contemplated that the cylinder 120 and the piston 140 are configured to form a combustion chamber 160. In examples, the engine block 100 may be constructed of a metal material, such as iron alloy, aluminum alloy, and or the like. As such, increased exposure of the engine block 100 and, thus, the combustion chamber 160, to unburned hydrogen remaining in the combustion chamber 160 may allow unburned hydrogen to be absorbed into the metal material used to construct the combustion chamber 160, which reduces ductility of the metal material and results in embrittlement and/or mechanical failure of the metal material and, thus, the combustion chamber 160.

Referring to FIG. 3-4, the coating system 200 is configured for use in the combustion chamber 160 of the engine. In particular, the coating system 200 is configured for use on the piston 140 of the combustion chamber 160. Additionally or alternatively, the coating system 200 may be considered and/or referred to as part of the piston 140. In examples, the piston 140 includes a body 142 extending between a first end 144 and a second end 146 about a longitudinal axis A-A. The body 142 of the piston 140 includes a crown 148 at the first end 144. The crown 148 includes a combustion surface 150 configured to face and/or define the combustion chamber 160. The combustion surface 150 and, thus, the crown 148, may define a cavity 152 configured for circulation, swirling, and/or combustion of the gaseous fuel-air mixture. In examples, the cavity 152 may be defined by a concave geometry of the combustion surface 150 and, thus, the crown 148. Additionally or alternatively, the cavity 152 may extend radially with respect to the axis A-A of the body 142.

Referring to FIG. 4, the crown 148 of the piston 140 may include one or more protrusion 154 configured to direct and/or redirect combustion of the gaseous fuel-air mixture within the cavity 152 of the crown 148 and, thus, the combustion chamber 160. In particular, the protrusion 154 may be configured to direct and/or redirect combustion of the gaseous fuel-air mixture toward a central point 156 of the cavity 152 of the crown 148, such that any oxygen remaining at the central point 156 of the cavity 152 is utilized for combustion. The protrusion 154 may extend toward the central point 156 of the crown 148. It is contemplated that a direction extending toward the central point 156 of the crown 148 may be considered and/or referred to herein as an “inward” direction and that a direction extending away from the central point 156 of the crown 148 may be considered and/or referred to herein as an “outward” direction. The protrusion 154 may be formed in a shape corresponding to a wave and/or undulation. In particular, the protrusion 154 may include a first ramp 154a and a second ramp 154b extending from the body 142 of the piston 140 to an apex 154c.

Referring to FIG. 4, the crown 148 may include a plurality of the protrusion 154. In examples, a first protrusion 154 of the plurality of protrusions 154 may be spaced-apart from a second protrusion 154 of the plurality of protrusions 154, such that a channel 158 is defined between the first protrusion 154 and the second protrusion 154. Referring to FIGS. 4 and 6, the channel 158 is configured to allow for circulation and/or combustion of the gaseous fuel-air mixture between the first protrusion 154 and the second protrusion 154 of the plurality of protrusions 154, such that combustion of the gaseous fuel-air mixture may be directed toward the central point 156 of the cavity 152 of the crown 148. It is contemplated that the first protrusion 154 and the second protrusion 154 of the plurality of protrusions 154 may be understood as and/or correspond to adjacent protrusions 154 of the plurality of protrusions 154. In examples, the crown 148 may include at least six protrusions 154. As such, the crown 148 may define a plurality of the channel 158, and each channel 158 of the plurality of channels 158 is defined between adjacent protrusions 154 of the plurality of protrusions 154. In examples in which the crown 148 includes at least six protrusions 154, the crown 148 may define at least six channels 158.

As shown in FIGS. 4-5, the coating system 200 includes a coating 220 configured to be applied within the combustion chamber 160. In particular, the coating 220 may be configured to be applied to the combustion surface 150 of the piston 140. Referring to FIG. 5, the coating 220 includes a first layer 222 configured decrease one or more of a thermal capacity and thermal conductivity of one or more of the coating 220 and the piston 140. Accordingly, the first layer 222 may also be referred to herein as the “thermal barrier coating layer 222.” In examples, the first layer 222 may be configured to maintain an operating temperature of the coating 220 within a range of 100° C. and 2,500° C. The first layer 222 may be configured to be deposited and/or bonded directly to the combustion surface 150 of the piston 140. In examples, the first layer 222 may be composed of a ceramic material having sufficient porosity for optimal thermomechanical performance, such as yttria-stabilized zirconia and/or the like. The first layer 222 may have a thickness within a range of 10 μm and 500 μm. In this manner, by including the first layer 222, the coating 220 is configured to improve combustion efficiency of the piston 140 by preventing premature heating of air included in the gaseous fuel-air mixture, thereby avoiding premature expansion of the air and reduction of oxygen available for a subsequent combustion stroke of the piston 140. Additionally or alternatively, in this manner, by including the first layer 222, the coating 220 is configured to improve combustion efficiency of the piston 140 by preventing premature ignition of the gaseous fuel-air mixture, thereby avoiding a malfunctioning and/or “rough running” or the engine.

Referring to FIG. 5, additionally or alternatively, the coating 220 may include a bond

layer 224 between the combustion surface 150 of the piston 140 and the first layer 222 of the coating 220, which is deposited and/or bonded directly to the combustion surface 150. The bond layer 224 may be composed of an alloy powder configured to increase a durability of adhesion between the first layer 222 and the combustion surface 150, such as MCrAlY (defined as iron, nickel, and/or cobalt combined with chromium, aluminum, and yttrium). The bond layer 224 may have a thickness within a range of 25 μm and 100 μm.

Referring to FIG. 5, the coating 220 includes a second layer 226 configured to decrease a permeability of the coating 220. In particular, the second layer 226 may be configured to decrease permeation of hydrogen through the coating 220. Accordingly, the second layer 226 may also be referred to herein as the “hydrogen barrier coating layer 226.” The second layer 226 may be configured to be deposited and/or bonded directly to the first layer 222. In examples, the second layer 226 may be composed of one or more of an oxide, nitride, and carbide having a low intrinsic hydrogen diffusivity and solubility, such as aluminum oxide, titanium aluminum nitride, titanium carbide, and/or the like. The second layer 226 may have a thickness within a range of 1 μm and 100 μm. In this manner, by including the second layer 226, the coating 220 is configured to prevent diffusion and/or absorption of hydrogen into the combustion surface 150 of the piston 140, thereby preventing a reduction in ductility and, thus, hydrogen embrittlement of the combustion surface 150 of the piston 140.

Referring to FIG. 5, the coating 220 includes a third layer 228 configured to facilitate combustion of the gaseous fuel-air mixture. Additionally or alternatively, the third layer 228 may be configured to initiate combustion of the gaseous fuel-air mixture. The third layer 228 may include a catalyst configured to facilitate and/or initiate combustion of the gaseous fuel-air mixture at a combustion reaction temperature lower than a normal hydrogen combustion reaction temperature (i.e. direct combustion of hydrogen without usage of a catalyst). Accordingly, the third layer 228 may also be referred to herein as the “catalytic coating layer 228.” The third layer 228 may be configured to be deposited and/or bonded directly to the second layer 226. In examples, the third layer 228 may be configured to initiate combustion of hydrogen. Additionally or alternatively, the third layer 228 may be configured to convert nitric oxide, nitrogen dioxide, and/or the like into nitrogen. In examples, the third layer 228 may be composed of one or more a noble-metal catalyst, a bimetallic catalyst, and/or the like capable of decreasing a combustion reaction temperature for combustion of hydrogen and/or converting combustion gases into nitrogen. The third layer 228 may have a thickness within a range of 1 μm and 100 μm. In this manner, by including the third layer 228, the coating 220 is configured to reduce a combustion reaction temperature for combustion of the gaseous fuel-air mixture, so as to be capable of initiating combustion of a fuel-lean gaseous fuel-air mixture, thereby improving combustion efficiency and reducing emissions of hydrocarbons, nitric oxide, nitrogen dioxide, and/or the like.

It is contemplated that the terms “fuel-rich” and “fuel-lean” as used herein may be understood as indicating a concentration of gaseous fuel within the gaseous fuel-air mixture, in that a fuel-rich gaseous fuel-air mixture has a greater concentration of gaseous fuel than a fuel-lean gaseous fuel-air mixture. Additionally or alternatively, the terms “fuel-rich” and “fuel-lean” as used herein may be understood with respect to a ratio between gaseous fuel and air in the gaseous fuel-air mixture. In examples, a stoichiometric ratio between gaseous fuel and air in a fuel-rich gaseous fuel-air mixture may be greater than 1:34 or 0.029 and a stoichiometric ratio between gaseous fuel and air in a fuel-lean gaseous fuel-air mixture may be less than 1:34 or 0.029.

Referring to FIG. 4, the coating system 200 includes a selective positioning and/or layout of the coating 220 configured to direct combustion of the gaseous fuel-air mixture along the combustion surface 150 of the piston 140 and, thus, within the combustion chamber 160. In examples, the coating system 200 may include one or more coating zone 240 of the coating 220. The coating zone 240 corresponds to one or more combustion position 162 on the combustion surface 150 of the piston 140 and/or within the combustion chamber 162. In examples, the one or more combustion position 162 may correspond to one or more fuel-lean region, or likelihood thereof, of the combustion surface 150 of the piston 140 and/or within the combustion chamber 160. Additionally or alternatively, the one or more combustion position 162 may correspond to one or more region of the combustion surface 150 of the piston 140 and/or within the combustion chamber 160 having an increased rate of exposure, or likelihood thereof, to water and/or thermal dilution. Additionally or alternatively, the one or more combustion position 162 may correspond to one or more region of the combustion surface 150 of the piston 140 and/or within the combustion chamber 160 having an increased concentration, or likelihood thereof, of nitric oxide, nitrogen dioxide, and/or the like. In examples, the combustion position 162 may be located at or adjacent to at least a portion of one or more channel 158 of the piston 140. In examples, the combustion position 162 may be located at or adjacent to at least a portion of a plurality of channels 158 of the piston 140. Additionally or alternatively, it is contemplated that the combustion position 162 may be located at or adjacent to at least a portion of one or more protrusion 154 of the piston 140. In examples, the combustion position 162 may be located at or adjacent to at least a portion of a plurality of the protrusions 154 of the piston 140.

In examples, the coating system 200 may include a plurality of the coating zone 240. Additionally, the coating system 200 may include a plurality of the combustion positions 162 on the combustion surface 150 of the piston 140. Each coating zone 240 of the plurality of coating zones 240 may correspond to one or more combustion position 162 of the plurality of combustion positions 162 on the combustion surface 150 of the piston 140. Additionally or alternatively, each coating zone 240 of the plurality of coating zones 240 may be arranged on a corresponding combustion position 162 of the plurality of combustion positions 162 on the combustion surface 150 of the piston 140, such that each combustion position 162 includes the coating 220. Each combustion position 162 of the plurality of combustion positions 162 may be spaced-apart from each other and, thus, each coating zone 240 of the plurality of coating zones 240 may be spaced apart from each other. Each combustion position 162 of the plurality of combustion positions 162 may be located at or adjacent to a corresponding channel 158 of the plurality of channels 158. Additionally or alternatively, each combustion position 162 of the plurality of combustion positions 162 may be located at or adjacent to a corresponding protrusion 154 of the plurality of protrusions 154. Additionally or alternatively, each combustion position 162 of the plurality of combustion positions 162 may be located at or adjacent to one or more of a corresponding channel 158 of the plurality of channels 158 and a corresponding protrusion 154 of the plurality of protrusions 154.

Accordingly, it is contemplated that the coating system 200 may include at least a first coating zone 240, a second coating zone 240, a third coating zone 240, a fourth coating zone 240, a fifth coating zone 240, and a sixth coating zone 240 corresponding to the at least six channels 158 and/or the at least six protrusions 154 of the piston 140. Additionally or alternatively, it is contemplated that the coating system 200 may include at least a first combustion position 162, a second combustion position 162, a third combustion position 162, a fourth combustion position 162, a fifth combustion position 162, and a sixth combustion position 162 corresponding to the at least six channels 158 and/or the at least six protrusions 154 of the piston 140.

In this manner, by the coating system 200 including the coating zone 240 at each combustion position 162 of the plurality of combustion positions 162 on the combustion surface 150 of the piston 140, the coating 220 may be selectively included at specified regions of the combustion surface 150 of the piston 140 and, thus, the combustion chamber 160. Accordingly, the coating system 200 is configured to selectively initiate combustion of the gaseous fuel-air mixture at specified regions of the combustion surface 150 of the piston 140 and, thus, the combustion chamber 160, thereby directing and optimizing a circulation of the gaseous fuel-air mixture and/or a combustion pattern of the gaseous fuel-air mixture. In this manner, the coating system 200 is configured to reduce thermal dilution and incomplete combustion of the gaseous fuel-air mixture and, thus, improve combustion efficiency within the combustion chamber 160.

It is contemplated that one or more of the first layer 222, the second layer 226, the third layer 228, and the bond layer 224 of the coating 220 may be deposited by a process of magnetron sputtering, reactive magnetron sputtering, electroless plating, hot-dip galvanization, flame spraying, plasma spraying, plasma electrolytic oxidation, radio frequency induction plasma spraying, electric arc spraying, gas detonation spraying, high-velocity oxy-fuel spraying, chemical vapor deposition, physical vapor deposition, anodization, hollow particle composite coating, sol-gel hydrolysis, additive manufacturing, powder sintering, powder calcining, hydrothermal treatment of alumina and silica with hydroxides, and/or the like. However, it is contemplated that alternative processes for depositing one or more of the first layer 222, the second layer 226, the third layer 228, and the bond layer 224 of the coating 220 may be compatible with the coating system 200. Additionally or alternatively, when depositing the coating 220, the combustion surface 150 of the piston 140 may be partially masked and/or shielded, such that only the coating zone 240 is exposed for depositing of the coating 220. In this manner, the coating 220 may be bonded to the combustion surface 150 of the piston 140 in the selective positioning and/or layout.

According to examples of the coating system 200, the coating system 200 may be provided as follows:

Example 1: A coating system 200 configured for use on a combustion surface 150 of a piston 140, the coating system including: a coating 220 configured to be applied to a combustion surface 150 of a piston 140 and to initiate combustion of a gaseous fuel-air mixture; a first coating zone 240 including the coating 220, the first coating zone 240 being configured to correspond to a first combustion position 162 on the combustion surface 150 of the piston 140; and a second coating zone 240 including the coating 220, the second coating zone 240 being configured to correspond to a second combustion position 162 on the combustion surface 150 of the piston 140.

Example 2: The coating system 200 according to Example 1, wherein the coating 220 includes a first layer 222 configured to decrease one or more of a thermal capacity and thermal conductivity of the coating 220.

Example 3: The coating system 200 according to Example 2, wherein the first layer 222 is configured to maintain an operating temperature of the coating 220 within a range of 100° C. and 2,500° C.

Example 4: The coating system 200 according to any of Examples 2-3, wherein the coating 220 comprises a second layer 226 configured to decrease permeability of the coating 220.

Example 5: The coating system 200 according to Example 4, wherein the second layer 226 is configured to decrease permeation of hydrogen.

Example 6: The coating system 200 according to any of Examples 4-5, wherein the coating 220 comprises a third layer 228 including a catalyst configured to initiate combustion of the gaseous fuel-air mixture.

Example 7: The coating system 200 according to Example 6, wherein the catalyst is configured to initiate combustion of hydrogen.

Example 8: The coating system 200 according to any of Examples 1-7, wherein the first coating zone 240 is spaced-apart from the second coating zone 240.

Example 9: The coating system 200 according to any of Examples 1-8, wherein the first combustion position 162 corresponds to a first channel 158 defined between a pair of radially-extending protrusions 154 provided on the piston 140.

Example 10: The coating system 200 according to Example 9, wherein the second combustion position 162 corresponds to a second channel 158 defined between a pair of radially-extending protrusions 154 provided on the piston 140.

Example 11: The coating system 200 according to any of Examples 1-10, wherein the first combustion position 162 and the second combustion position 162 correspond to regions of the combustion surface 150 of the piston 140 having a gaseous fuel-air ratio less than 0.029.

Example 12: A piston 140 configured for use in an engine block 100 of a vehicle 10, the piston 140 including: a body 142 extending between a first end 144 and a second end 146 about a longitudinal axis A-A; a crown 148 included at the first end 144 of the body 142, the crown 148 being configured for combustion of a gaseous fuel-air mixture, the crown 148 including a plurality of radially-extending protrusions 154; and the coating system 200 according to any of Examples 1-11.

Example 13: The piston 140 according to Example 12, wherein each radially-extending protrusion 154 of the plurality of radially-extending protrusions 154 is spaced-apart from an adjacent radially-extending protrusion 154 of the plurality of radially-extending protrusions 154.

Example 14: The piston 140 according to any of Examples 12-13, including a first channel 158 defined between a first pair of radially-extending protrusions 154 of the plurality of radially-extending protrusions 154 and a second channel 158 defined between a second pair of radially extending protrusions 154 of the plurality of radially extending protrusions 154.

Example 15: The piston 140 according to Example 14, wherein the first coating zone 240 of the coating 220 is arranged within the first channel 158 of the piston 140.

Example 16: The piston 140 according to claim any of Examples 12-14, wherein the first coating zone 240 of the coating 220 is arranged on one or more radially-extending protrusion 154 of the plurality of protrusions 154.

Example 17: The piston 140 according to any of Examples 12-16, wherein the second coating zone 240 of the coating 220 is arranged within the second channel 158 of the piston 140.

Example 18: The piston 140 according to any of Examples 12-16, wherein the second coating zone 240 of the coating 220 is arranged on one or more radially-extending protrusion 154 of the plurality of radially-extending protrusions 154.

Example 19: A method of directing combustion of a gaseous fuel-air mixture along a combustion surface 150 of a piston 140, the method including: providing the coating system (200) according to any of Examples 1-11; applying the first coating zone 240 of the coating 220 to a first combustion position 162 of a combustion surface 150 of a piston 140; and applying the second coating zone 240 of the coating 220 to a second combustion position 162 of the combustion surface 150 of the piston 140.

Example 20: The method according to Example 19, wherein the method includes determining a region of the combustion surface 150 of the piston 140 having a gaseous fuel-air ratio less than 0.029.

Example 21: The method according to any of Examples 19-20, wherein the method includes applying the first coating zone 240 spaced-apart from the second coating zone 240.

Example 22: The method according to any of Examples 19-21, wherein the method includes the first combustion position 162 being included within a first channel 158 defined between a first pair of radially-extending protrusions 154 included by the piston 140 and the second combustion position 162 being included within a second channel 158 defined between a second pair of radially-extending protrusions 154 included by the piston 140.

Although the present disclosure herein has been described with reference to particular examples, it is to be understood that these examples are merely illustrative of the principles and applications of the present disclosure.

It is intended that the specification and examples be considered as exemplary only. with a true scope of the disclosure being indicated by the following claims.

Additionally, all of the disclosed features of an apparatus may be transposed, alone or in combination, to a method and vice versa.

What is claimed is:

1. A coating system configured for use on a combustion surface of a piston, the coating system comprising:
a coating configured to be applied to a combustion surface of a piston and to initiate combustion of a gaseous fuel-air mixture;
a first coating zone including the coating, the first coating zone being configured to correspond to a first combustion position on the combustion surface of the piston; and
a second coating zone including the coating, the second coating zone being configured to correspond to a second combustion position on the combustion surface of the piston.

2. The coating system of claim 1, wherein the coating comprises a first layer configured to decrease one or more of a thermal capacity and thermal conductivity of the coating.

3. The coating system of claim 2, wherein the coating comprises a second layer configured to decrease permeability of the coating.

4. The coating system of claim 3, wherein the coating comprises a third layer including a catalyst configured to initiate combustion of the gaseous fuel-air mixture.

5. The coating system of claim 1, wherein the first coating zone is spaced-apart from the second coating zone.

6. The coating system of claim 1, wherein the first combustion position corresponds to a first channel defined between a pair of radially-extending protrusions provided on the piston.

7. The coating system of claim 6, wherein the second combustion position corresponds to a second channel defined between a pair of radially-extending protrusions provided on the piston.

8. The coating system of claim 1, wherein the first combustion position and the second combustion position correspond to regions of the combustion surface of the piston having a gaseous fuel-air ratio less than 0.029.

9. A piston configured for use in an engine block of a vehicle, the piston comprising:
a body extending between a first end and a second end about a longitudinal axis;
a crown included at the first end of the body, the crown being configured for combustion of a gaseous fuel-air mixture, the crown including a plurality of radially-extending protrusions; and
the coating system of claim 1.

10. The piston of claim 9, wherein each radially-extending protrusion of the plurality of radially-extending protrusions is spaced-apart from an adjacent radially-extending protrusion of the plurality of radially-extending protrusions.

11. The piston of claim 9, comprising a first channel defined between a first pair of radially-extending protrusions of the plurality of radially-extending protrusions and a second channel defined between a second pair of radially extending protrusions of the plurality of radially extending protrusions.

12. The piston of claim 11, wherein the first coating zone of the coating is arranged within the first channel of the piston.

13. The piston of claim 11, wherein the second coating zone of the coating is arranged within the second channel of the piston.

14. A method of directing combustion of a gaseous fuel-air mixture along a combustion surface of a piston, the method comprising:
providing the coating system of claim 1;
applying the first coating zone of the coating to a first combustion position of a combustion surface of a piston; and
applying the second coating zone of the coating to a second combustion position of the combustion surface of the piston.

15. The method of claim 14, wherein the method comprises applying the first coating zone spaced-apart from the second coating zone.
